(19) United States
(12) Patent Application Publication
(10) Pub. No.: US 2012/0011449 A1
(43) Pub. Date: Jan. 12, 2012

(54) MESSAGING SYSTEM

(76) Inventors: Ori Sasson, San Francisco, CA (US); Igor Neyman, Palo Alto, CA (US)

(21) Appl. No.: 12/859,477

(22) Filed: Aug. 19, 2010

Related U.S. Application Data
(60) Provisional application No. 61/362,885, filed on Jul. 9, 2010.

(51) Int. Cl. G06F 3/01; G06F 15/16

(52) U.S. Cl. 715/752

(57) ABSTRACT

A method for communication includes steps for (a) connecting to a network-connected server by a subscriber operating a computerized appliance, (b) accessing by the subscriber an interactive interface provided by software executing on the server, (c) selecting by the subscriber in the interactive interface provided by the server, a quick-response format, a recipient or a destination for a recipient, (d) entering by the subscriber a message body and triggering sending of the message, (e) transmitting by the sever the message to the recipient's computerized appliance, the message including interactive code that provides an interactive interface on a display of the recipient's computerized appliance of at least the message body and one or more quick-response interactive soft keys dictated by the format selected by the subscriber in preparing the message, such that the recipient may select one of the soft keys to send a response back to the subscriber.

### CROSS-REFERENCE TO RELATED APPLICATIONS

This application claims priority to provisional patent application 61/362,885 filed on Jul. 9, 2010, and that application is incorporated in its entirety at least by reference.

### BACKGROUND OF THE INVENTION

1. Field of the Invention

The present invention is in the field of network-enabled communication, and pertains more particularly to systems for efficient text-based communication between hand-held digital devices, such as cellular telephones and personal digital assistants.

2. Description of Related Art

Text-based messaging between digital devices is well-known in the art, and typically requires users to compose messages using physical or soft-key keyboards, and to respond to such messages by reading received message and keying in and sending the response. In some cases in such messaging systems a means of defining question/response in a way that facilitates quick response, and of accomplishing other ends very efficiently, such as including attachments in responses, is highly desirable.

What is clearly needed in the art are apparatus and methods for creation, by either a user or a machine, messages in a way that enables quick responses for a recipient, and enables dynamic responses by recipients and senders of such messages.

### SUMMARY OF THE INVENTION

The problem stated above is that more efficiency is desirable for a messaging system, but many of the conventional means for sending and receiving messages, such as email, also include multiple step processes required to exchange information and attachments. The inventors therefore considered functional elements of a network-based messaging system, looking for elements that could potentially be harnessed to provide communication by way of messaging between mobile and fixed devices, but in a manner that would not create extra process steps for exchanging information or sharing content.

The present inventor realized in an inventive moment that if, at the point of message creation, response buttons comprising executable commands could be included in a message for facilitating recipient interaction, significant reduction in steps required to share content or perform certain tasks might result. The inventor therefore constructed a unique messaging application for fixed and mobile communications appliances that allowed certain manual interaction steps to be automated. A significant reduction in user workload results, with no impediment to quality or utility created.

Accordingly, in one embodiment of the invention, a system for communication is provided. The system includes a network-connected server enabled for communication with individual ones of a plurality of network-connected computerized appliances, and software executing on the server from a machine-readable physical medium. The software executing at the server provides an interactive interface to a subscriber, on a display of the subscriber's computerized appliance, for creating a message to be sent to an intended recipient's computerized appliance, the interactive interface provided to the subscriber providing functionality for the subscriber to dynamically select a quick-response format, to select a recipient or enter a destination for a recipient, to enter a message body, and to trigger sending of the message, and the message, when sent, includes executable code that provides an interactive interface on a display of the recipient's computerized appliance of at least the message body and one or more quick-response interactive soft keys dictated by the format selected by the subscriber in preparing the message, such that the recipient may select one of the soft keys to send a response back to the subscriber.

In one embodiment, the subscriber's computerized appliance is one of a cellular telephone, a desktop computer, a laptop computer, a personal digital assistant, or a digital pad device with a touch screen display. In one embodiment, the recipient is also a subscriber, and the system stores information about potential recipients, including types of computerized appliances associated with the intended recipients and addresses for sending messages to those devices, such that a subscribe preparing a message may select recipients from stored data, and may also select appliances associated with recipients.

In one embodiment, the quick-response formats selectable by a subscriber in preparing a message to be sent define one or more pre-stored soft keys for the recipient's display. In one embodiment, the quick-response formats selectable by a subscriber in preparing a message to be sent include functionality enabling the subscriber to create one or more new soft keys to be provided in a recipient's display. In one embodiment, the quick-response format selected provides executable code sent with the message that causes activity at a recipient's computerized appliance in addition to or instead of one or more interactive soft keys. In a variation of this embodiment, the activity triggered at the recipient's appliance is connecting to a digital storage coupled to the recipient's appliance. In another variation of this embodiment, the activity further comprises retrieval of data from the digital storage.

In one embodiment, the software executing on the server provides archival and historical storage of messages sent and received, and access for subscribers to the stored data. In one embodiment, the software executing on the server provides a personalized page to a subscriber, wherein the subscriber may manage personalized quick-response formats.

According to one aspect of the present invention, a method for communication is provided and includes the steps (a) connecting to a network-connected server by a subscriber operating a computerized appliance, (b) accessing by the subscriber an interactive interface provided by software executing on the server, (c) selecting by the subscriber in the interactive interface provided by the server, a quick-response format, a recipient or a destination for a recipient, (d) entering by the subscriber a message body and triggering sending of the message, and (e) transmitting by the sever the message to the recipient's computerized appliance, the message including interactive code that provides an interactive interface on a display of the recipient's computerized appliance of at least the message body and one or more quick-response interactive soft keys dictated by the format selected by the subscriber in preparing the message, such that the recipient may select one of the soft keys to send a response back to the subscriber.

In one aspect of the method, in step (a), the subscriber's computerized appliance is one of a cellular telephone, a desktop computer, a laptop computer, a personal digital assistant, or a digital pad device with a touch screen display. In one aspect, in step (c), the recipient is also a subscriber, and the system stores information about potential recipients, including types of computerized appliances associated with the intended recipients and addresses for sending messages to those devices, such that a subscriber preparing a message may select recipients from stored data, and may also select appliances associated with recipients.

In one aspect of the method, in step (c), the quick-response formats selectable by a subscriber in preparing a message to be sent define one or more pre-stored soft keys for the recipient's display. In another aspect, in step (c), the quick-response formats selectable by a subscriber in preparing a message to be sent include functionality enabling the subscriber to create one or more new soft keys to be provided in a recipient's display. In one aspect, in step (c), the quick-response format selected provides executable code sent with the message that causes activity at a recipient's computerized appliance in addition to or instead of one or more interactive soft keys. In a variation to the same aspect, the activity triggered at the recipient's appliance is connection to a digital storage coupled to the recipient's appliance. In the same aspect and according to a further variation, the activity further comprises retrieval of data from the digital storage.

In one aspect, the software executing on the server additionally provides archival and historical storage of messages sent and received, and access for subscribers to the stored data. In a variation to this aspect, the software executing on the server additionally provides a personalized page to a subscriber, wherein the subscriber may manage personalized quick-response formats.

### BRIEF DESCRIPTION OF THE DRAWING FIGURES

FIG. 1A is an architectural overview of a networked system in which embodiments of the present invention may be practiced.

FIG. 1B is a screen shot of the interface of FIG. 1 for creating a message.

FIG. 2 is a screen shot of the interface of FIG. 1 for selecting a quick response interactive for insertion into a message to a recipient.

FIG. 3 is a screen shot of the interface of FIG. 1 for selecting and configuring response options under the quick response interactive selected in FIG. 1.

FIG. 4 is the screen shot of FIG. 1 in a circumstance where a different option is selected.

FIG. 5 is a screen shot of the interface of FIG. 1 for creating a customized quick response interactive.

FIG. 6 is a screen shot of the interface of FIG. 1 for configuring the customized quick response interactive of FIG. 5.

FIG. 7 is a screen shot of the interface of FIG. 1 for setting an action for a custom quick response option.

FIG. 8 is a screen shot of the interface of FIG. 1 for setting a notification channel for receiving notification of interaction with the inserted quick response interactive.

FIG. 9 is a screen shot of the interface of FIG. 1 for setting an action concerning notification relative to recipient interaction with a quick response menu.

FIG. 10 is a screen shot of the interface of FIG. 1 for previewing a message sent to a recipient based on the configurations in FIGS. 8 and 9.

FIG. 11 is a screen shot of the interface of FIG. 1 depicting an IPod music library opened as a result of interaction with the message of FIG. 10.

FIG. 12 is a screen shot of the interface of FIG. 1 depicting a response message to the message of FIG. 10.

FIG. 13 is a screen shot of the interface of FIG. 1 depicting another message sent to a recipient.

FIG. 14 is a screen shot of the interface of FIG. 1 depicting a response message to the message of FIG. 13.

FIG. 15 is a screenshot of the interface of FIG. 1 depicting a message for rating content.

FIG. 16 is a screenshot of the interface of FIG. 1 depicting a rating menu invoked from selecting rate it in the screenshot of FIG. 15.

FIG. 17 is a screenshot of the interface of FIG. 1 depicting a message asking for a meeting.

FIG. 18 is a screenshot of the interface of FIG. 1 depicting a date wheel invoked from selecting yes in the screenshot of FIG. 17.

FIG. 19 is a screenshot of the interface of FIG. 1 depicting a message asking for location for a meeting.

FIG. 20 is a screenshot of the interface of FIG. 1 depicting a map and asking for permission to use the current GPS location coordinates.

FIG. 21 is a screenshot of the interface of FIG. 1 depicting a message inviting a recipient to a content hosting Web page.

FIG. 22 is a screenshot of the content page navigated to as a result of interaction with a quick response button in the message of FIG. 21.

FIG. 23 is a screenshot of the interface of FIG. 1 depicting a message asking the recipient to comment on a photo in the message.

FIG. 24 is a screenshot of the interface of FIG. 1 depicting a messaging window and keyboard for forming the comment requested in the message of FIG. 23.

FIG. 25 is a screenshot of the interface of FIG. 1 depicting a message requesting the recipient to send a voice message in reply.

FIG. 26 is a screenshot of the interface of FIG. 1 depicting an audio recording utility displayed in the interface for recording audio for the reply message.

FIG. 27 is a screenshot of the interface of FIG. 1 depicting a message requesting that the recipient send photos.

FIG. 28 is a screenshot of the interface of FIG. 1 depicting a photo collection in the interface for enabling the recipient to select one or more photos for insert into a reply message.

FIG. 29 is a screenshot of the interface of FIG. 1 depicting a message asking the recipient to send a song preview.

FIG. 30 is a screenshot of the interface of FIG. 1 depicting a music collection opened in the interface for enabling the recipient to select a song for insert into a reply message.

FIG. 31 is a screen shot of the interface of FIG. 1 depicting a list of promotional messages received as a result of opting in to receive such advertisements.

FIG. 32 is a screen shot of the interface of FIG. 1 depicting a promotional message under the advertiser name (Swissotel) selected in the example of FIG. 31.

FIG. 33 is the screen shot of FIG. 32 illustrating the more granular quick response options available by invoking the original interactive buttons.

### DETAILED DESCRIPTION

The inventors provide a messaging system that enables users to interact by sending and responding to quick response interactives inserted into messages. The methods and apparatus of the present invention are described in enabling detail using the following examples, of which may describe more than one embodiment.

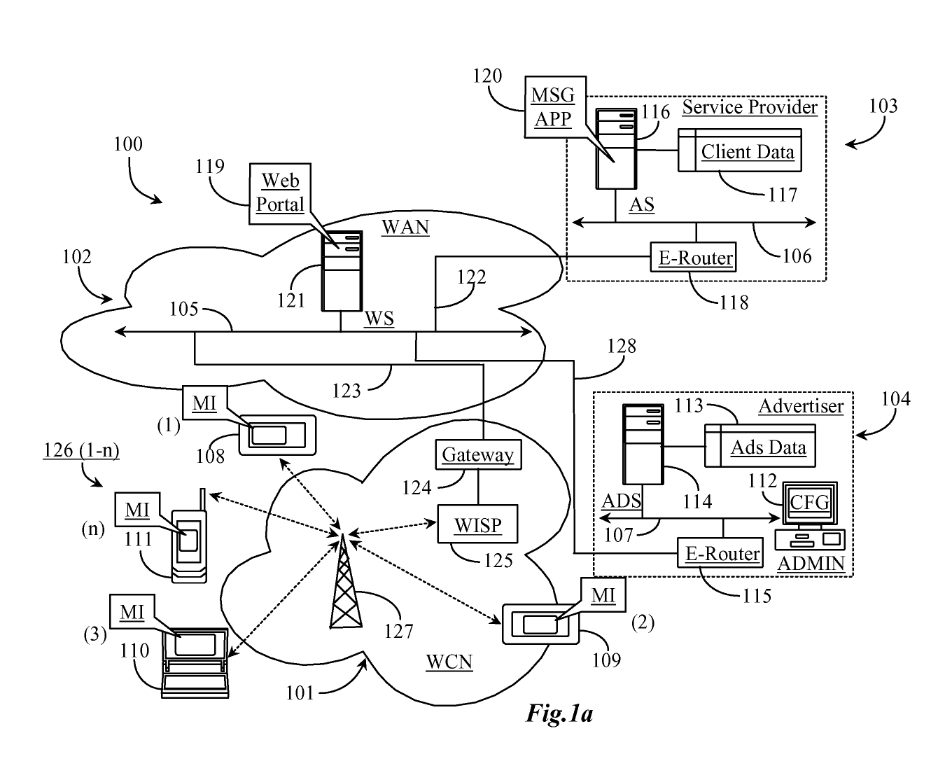

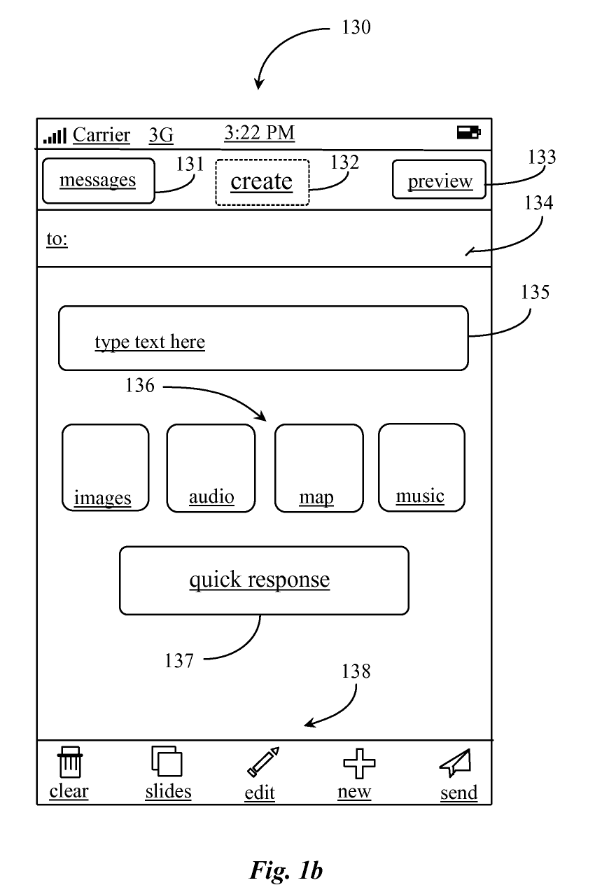

FIG. 1A is an architectural overview of a communications network 100 in which embodiments of the present invention may be practiced. Communications network 100 includes a wireless carrier network (WCN) 101. WCN 101 represents any wireless cellular network adapted as a carrier network for wireless communications devices. WCN 101 is logically represented herein by a cloud that includes a cellular tower 127, a wireless Internet service provider (WISP), and a media gateway 124 that connects WCN 101 to an external network like a wide area network (WAN) 102,

WCN may represent one large cellular network or many cellular network segments spanning a large geographic area. WCN 101 may also be seamlessly connected to any other telephone network including the well-known public switched telephone network (PSTN), which is not illustrated here. Clients who may practice the present invention include users having communications devices such as 108, 109, 110, and 111, all of which are enabled as voice communications devices and Internet capable appliances. In this example, communications device 108 is a smart phone or a personal digital assistant (PDA), typically 3^{rd} or 4^{th} generation (3G, 4G). Communication device 109 is also a smart phone or a PDA in this example. Smart phones/PDAs 108 and 109 are touch screen enabled in this example. Communications device 110 is a Laptop computer and communications device 111 is a cellular telephone. iPAD type devices and fixed desktop computers may also be used in practice of the present invention.

In a preferred embodiment of the present invention, the interactive messaging system provides richer and quicker communications sessions for both private citizens and business applications such as advertising campaigns and product/service promotions. WCN 101 has connection to WAN 102 through media gateway 124 and Internet access line 123. WAN 102 may be a private or corporate WAN or a public WAN like the Internet network, for example. In one embodiment WAN 102 is the Internet network and may be referred to as Internet 102 in this example and in examples to follow in this specification.

WAN 100 includes a network backbone 105. Network backbone 105, in a preferred embodiment, logically represents all of the lines, equipment, and access points that make up the Internet network as a whole. Therefore, there are no geographic limitations to practicing the present invention. A service provider 103 is illustrated in this example, and is adapted to provide the messaging software and service of the present invention. Service provider 103 may be any company with authorization to provide the service to a client base. Service provider 103 provides the service, brokers communication, and provides an advertising platform, in one embodiment, for businesses to reach potential customers using mobile devices that leverage the messaging application and technology to enable efficient interaction between an agent of the business and a potential customer through brokered messaging communication.

Service provider 103 includes a local area network (LAN) 106 that is adapted with transfer control protocol over Internet protocol (TCP/IP) and other Internet protocols. LAN 106 has connection to network backbone 105 in WAN 102 via an edge router (E-Router) 118 and network access line 122. E-router 118 represents any router or gateway for bridging one network or network segment to another network or network segment. LAN 106 supports an application server 116. Application server (AS) 116 has a digital medium contained therein or otherwise accessible thereto that includes all of the data and software that is require to enable server function as an application server. AS 116 provides support for brokering communications using a messaging application (MSG APP) 120 installed on the server. MSG APP 120 is a parent application that is server based and that may be made accessible through a Website or Web portal.

AS 116 has connection to a data repository 117 labeled Client Data. Repository 117 is adapted to contain information about registered users of the messaging system of the present invention. Repository 117 may be an optical, mechanical, solid state, or a magnetic data storage system without departing from the spirit and scope of the present invention. Client data may include billing information, demographic data, location data, and contact information for clients of the service. MSG APP 120 includes the parent service application, configuration application, and logic for brokering communications and managing dynamic responses from clients using the service in the advertising B2B mode.

Backbone 105 in WAN 102 supports a Web server (WS) 121. Web server 121 has a digital medium contained therein or otherwise accessible thereto that includes all of the data and software that is require to enable server function as a Web server. Web server 121 hosts a Web portal 119 for business users of the service of the invention. Business users may login to Web portal 119 and configure a targeted advertising campaign that includes message-delivered ads and dynamic response management to those ad messages that are interacted with by message recipients. In one embodiment Web portal 119 also supports social users of the messaging service of the present invention. In a preferred embodiment WAN 102 is the Internet network because of its high public access characteristic.

An advertiser 104 is illustrated in this example and represents any company that advertises to mobile consumers. Advertiser 104 includes a LAN 107 adapted with TCP/IP and other Internet protocols. LAN 106 of advertiser 104 has connection to backbone 105 in WAN 102 through an edge router (E-Router) 115 and a network access line 128. LAN 107 supports an ad server (ADS) 114 adapted to store and serve advertisements and advertisement data. ADS 114 has a digital medium contained therein or otherwise accessible thereto that includes all of the data and software that is required to enable server function as an ad server. ADS 114 has connection to a data repository 113 labeled Ads Data. Data repository 113 may be an optical, mechanical, solid-state, or magnetic storage system without departing from the spirit and scope of the present invention.

Repository 113 may contain ads for upload to the service of the present invention for the purpose of including those ads in targeted messages which are broadcast to potential customers using mobile end devices. Repository 113 may also store ad data or data about ads such as ad response statistics, customer data from customers whom have responded to advertisements, etc. LAN 107 supports a connected personal computer (PC) 112 labeled ADMIN for administration. PC 112 is adapted with the aid of a configuration interface (CFG) 129 to enable an administrator or other authorized agent of the advertising business to configure advertising services using the messaging application of the present invention and an advertising platform offered by service provider 103. CFG interface 129 may be hosted by Web portal 119 and may be accessible to an agent of the ad business through PC 112 connected to server 121 and Web portal 119. In one embodiment CFG interface 129 is downloaded to PC 112 as a browser-based plug in, extension, or as a client interface of or as a whole standalone messaging application. In a preferred embodiment the messaging interface is the client application and the parent resides on the server, such as AS 116.

Users operating end devices such as devices 108-111 may acquire the messaging application of the present invention as a messaging interface (MI) downloaded as an installation such as a browser-based plug in. Messaging interfaces (MI) 126 (1-n) illustrated on end devices 108-111 respectively. Instances of MI 126 (1-n) may differ according to what type of device supports the plug in. For example, a plug in for an apple iPod might be different from a plug in for a windows XP box. A laptop user may have a more robust installation than a cellular phone user. The exact granularity of messaging capability and feature description of an instance of the message interface is somewhat device dependant. MI 126 (1-n) may be considered a client application to MSG application 120. It is noted herein that MI 126 (1-n) also includes configuration capabilities for selecting and creating and programming quick response options for recipients to interact with.

In social practice of the present invention, users may be any person having an end device like one of devices 108-111 connected to the Internet. Any user may be a sender or a recipient at any time. MI 126 (1-n) are instances of messaging application that are installed on each user's mobile or tethered appliance. The invention may be practiced using some fixed endpoint devices like a computer or cable box. However, mobile end devices are used most often for messaging and are becoming much more popular as shopping utilities.

In one embodiment of the present invention, a user operating device 109, for example, wants to send a message with a quick response option to a user operating device 108. In this example, assume that the message is a social message and not a solicitation. The person operating phone 109 may invoke MI (n), which activates a new instance of the messaging application for the sender to utilize to configure and send a message to a recipient. Upon invocation of MI 126 (n), the application opens and makes a connection to AS 116 hosted on LAN 106 on the provider's premises.

Using drag and drop, the sender may configure one or more quick response buttons, which are action buttons having pre-programmed but swappable coding for instructing the recipient machine to perform one or more tasks to make the interaction more smooth. The configured message is sent from AS 116 to the recipient, in this case, end device 108. In one example, a quick response button may simply ask a question such as “where are you?”. If the recipient clicks on the where are you button, the service will send the location information back to the sender through AS 116 as a proxy. In a preferred embodiment, a sender is afforded the capability of directing the types of responses that he or she wishes to receive from a recipient of a message. Any combination of devices might be involved in a messaging session as long as each device is capable of send and receiving messages that are visually displayable on a screen that can be manipulated by touch or cursor.

In an advertisement example, a user operating PC 112 may configure a promotion for a product or service and then upload the promotion to AS 120, which includes an advertising platform (not illustrated) as part of MSG APP 120. The service will broadcast the promotion through messaging to a targeted subset of application users defined as those users whom have downloaded and installed the application plug in. Additional demographic information may also be uploaded to the service concerning the type of consumer that should be targeted. In one example, the service determines which type of consumer to broadcast the advertisement message to. An operator using PC 112 to configure an ad campaign with the aid of CFG interface 129 may pre-configure additional automatic response options for reply to consumers whom have interacted with the advertisement by clicking one response button wherein the automatic reply content and functionality of the additional automatic responses is based upon the nature and content of the consumers' original responses.

Messages are composed of slides. Each slide can contain any combination of text, media and one-touch response buttons (Quick Response Buttons or Soft Keys). Media types include image, audio, video, and location information, which may be presented as a Map, or some other location data such as coordinates, directions, or the like. A message may include a single slide or multiple slides. In the case of multiple slides, a recipient of the message may scroll through each slide by swiping his or her finger to the right or to the left (touch screen) or by cursor movement or some other input mechanism. A slide may be thought of as an electronic page that contains the message data and content for dissemination.

FIG. 1B is a screenshot 130 of the interface of FIG. 1 for creating a message. Screenshot 130 may be a first screen that appears when a user decided to create a new message. Screen 130 includes an interactive option 131 for viewing messages. An interactive option 132 is provided for initiating a new message. The broken boundary of option 132 indicates that the user is initiating a brand new message. Screen 130 also has an interactive option for previewing any created messages.

Screen 130 has a recipient line 134 for typing in the messaging address of the intended recipient or recipients of the new message. A text box 135 is provided for creating a text message body. A plurality of interactive buttons 136 enables the sender to add one or more images, one or more audio clips, one or more maps, or one or more music clips to the message. Selecting audio bring up an audio recorder for voice recording and insert into the message.

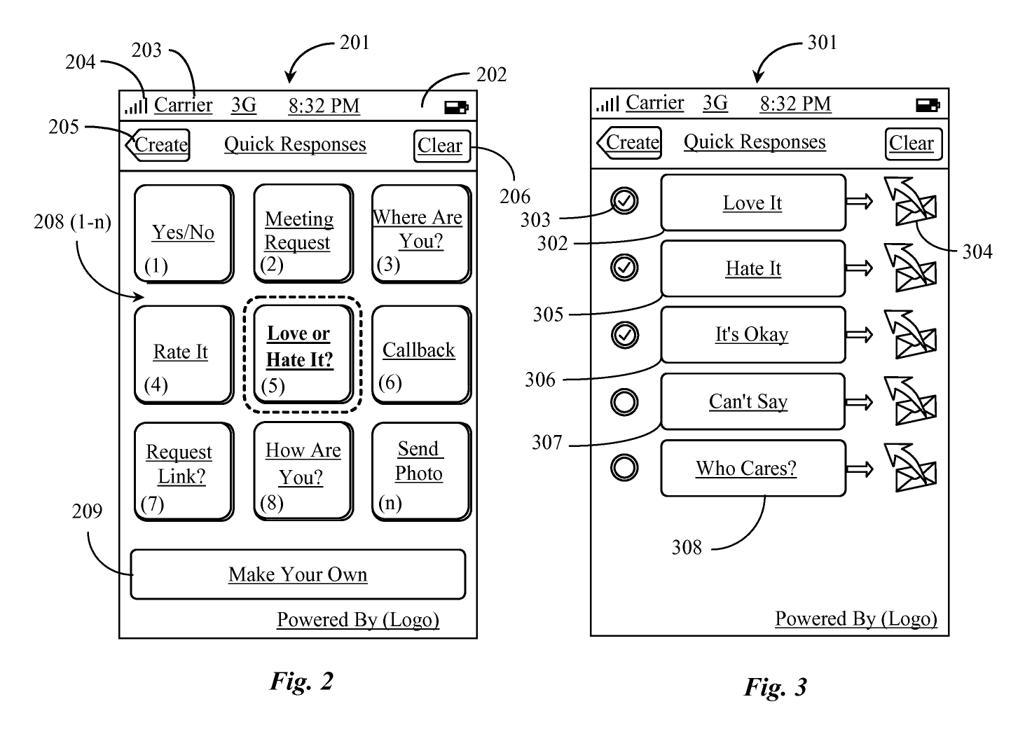

Screen 130 includes and interactive option 137 for selecting one or more quick responses. When this option is selected a different screen appears containing quick response options for selection as will be seen further below in the example of FIG. 2. Other useful options 138 include a clear option for erasing content, a slides option for adding and or deleting message slides, an edit option for editing the message before send, a new message option for initiating another new message, and a send option for sending a created message to an intended recipient or to multiple recipients.

FIG. 2 is a screenshot 201 of the interface of FIG. 1 for selecting a quick response interactive for insertion into a message to a recipient. Screen 201 appears as a result of selection of quick response button 137 of FIG. 1A. The interface may be a social-oriented version of CFG interface 129 of FIG. 1 or a CFG screen of MI 126 (1-n). The interface may be supported by AS 120 as previously described which is accessible through Web portal 119 or a Web site hosted for the purpose. Each user may be allotted a certain amount of storage space in order to store quick response configurations that are selected and, in one embodiment, user defined in terms of functionality. In this way, the user has quick access to all of the quick response options available to her including system generic response actions and custom response actions.

Screenshot 201 is adapted for display on a mobile device such as a smart phone. A title bar 202 illustrates certain static features like bar strength 204, the carrier network identification 203, for example, ATT, Verizon, etc. A create option 205 is provided on the face of screenshot 201 for enabling a user to create a “one touch” quick response button also termed a soft key. A clear option 206 is provided for clearing the interface of created or selected response data.

In this example, there are a plurality of quick response buttons 208 (1-n) that are pre-created by the service provider and are stock options that can be selected and that can be edited in terms of the action set for the response button. Reading generally from left to right and down, there is a Yes/No quick response button 208 (1), a Meeting Request quick response button, a “Where Are You?” quick response button, a Rate It quick response button, a Love it or Hate it quick response button, a Call back quick response button, a Request Link quick response button, a How Are You quick response button, and a Send Photo quick response button. Buttons 208 (1-n) are pre-configured for action, but the pre-configuration may be changed or altered by a user. An interactive button 209 labeled “Make Your Own” is provided and located below the stock quick response button group 208 (1-n). Button 209 enables the operator to make his or her own custom quick response buttons including the ability to set actions and change response option menus. Actions associated with quick response button may be changed from stock actions by the user. Indication of the company providing the interface is located at the bottom of screen 201. In this example, a user has selected quick response button 208 (5), which is the stock “Love or Hate it” button. Indication of selection is logically illustrated by bold text and a broken boundary. Invocation of button 208 (5) causes a next interface screen to display.

FIG. 3 is a screenshot 301 of the interface of FIG. 1 for selecting and configuring response options under the quick response interactive selected in FIG. 2. Screen 301 has 5 stock option buttons to include with the main quick response button. These are option 302 “Love It”, option 305 “Hate It”, option 306 “It's Okay”, option 307 “Can't Say, and option 308 “Who Cares?”. The just-mentioned options are selectable by marking radio buttons 303. In this example the first three options are selected. The remaining two options are ignored. This causes the three menu option buttons to be displayed in the recipient's message whenever the message recipient clicks on the Love Hate It button 208 (5) inserted into the message.

The sender has the ability to set or swap actions for each of the selected quick response options. Action set icons 304 enable the user to set and save a specific action for the quick response options. Setting an action may involve adding some predetermined code that executes on the recipient's communication device when the option response button is clicked by the recipient.

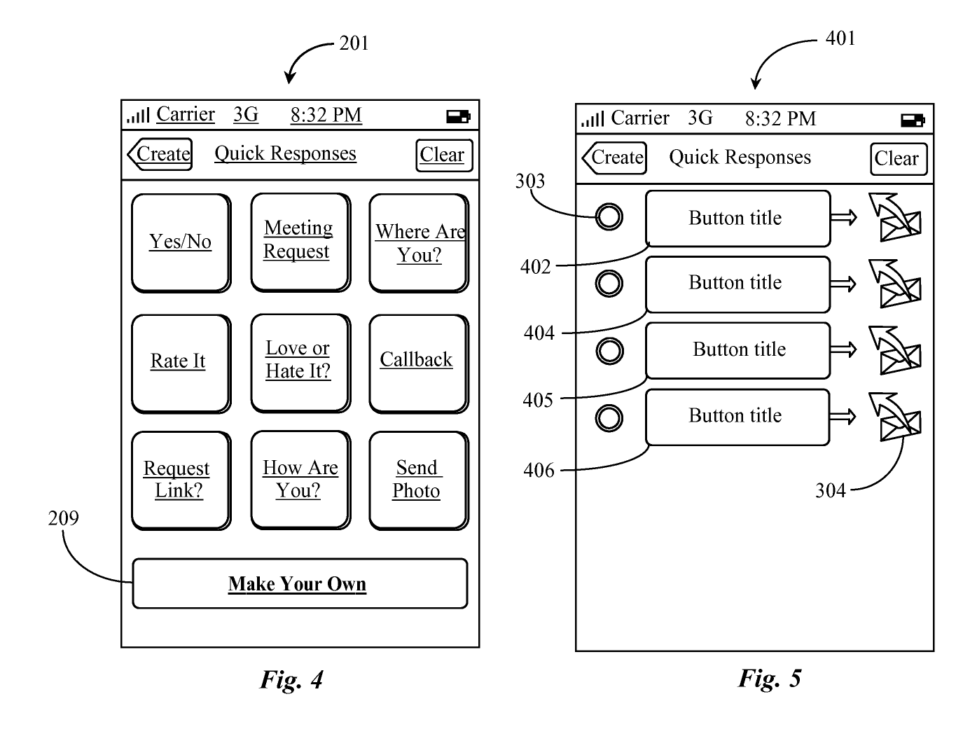

FIG. 4 is the screenshot 201 of FIG. 2 in a circumstance where a different option is selected. In this example, the user has decided to make a custom quick response button rather than select a stock option. To do this the sender selects the option 209 “Make Your Own”. Selecting this option causes a next screen to appear in the interface.

FIG. 5 is a screenshot 401 of the interface of FIG. 1 for creating a customized quick response interactive. Screen 401 includes four blank or unassigned buttons. These are buttons 402, 404, 405, and 406. Radio buttons 303 are associated one per with each option. Set action buttons 304 are associated one per each option. The sender may select a number of buttons and may name each of the selected buttons. The user may then set the actions for all of the interactive buttons that will be included in the message. Selecting a button to name causes a new screen to appear.

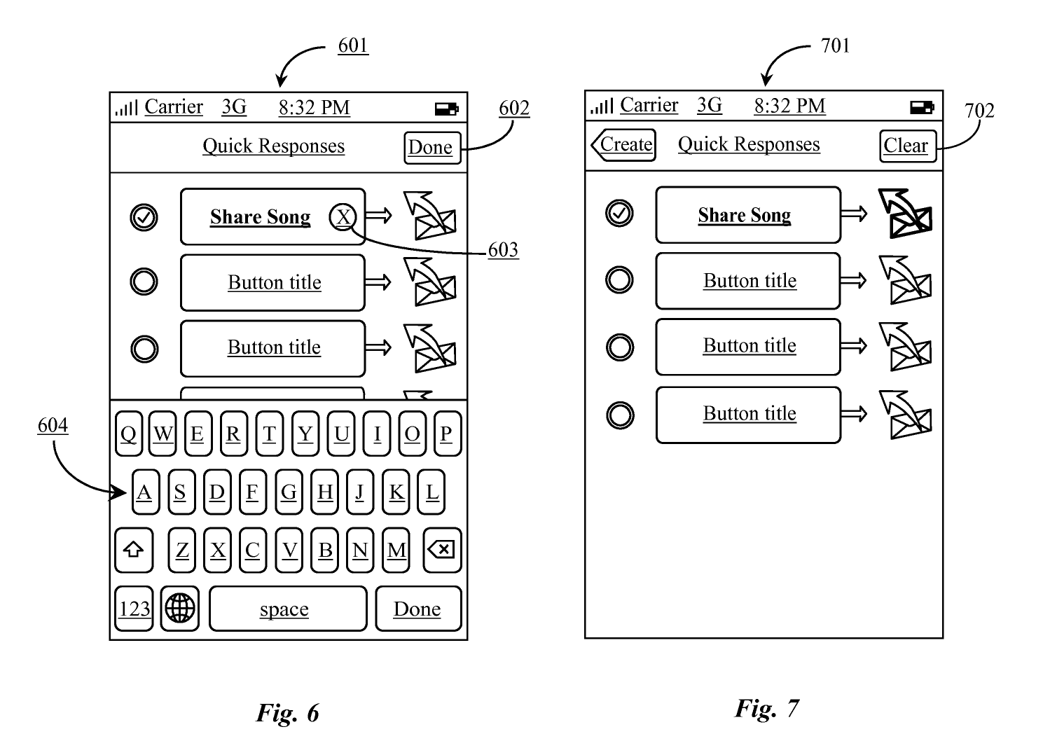

FIG. 6 is a screenshot 601 of the interface of FIG. 1 for configuring the customized quick response interactive buttons of FIG. 5. Screen 601 has a keyboard input interface 604. Input interface 604 may be a touch screen virtual keyboard or an actual keyboard input device that is integrated with or coupled to a communications device such as a smartphone or a PDA. In this example, an interactive button is selected and named “Share Song”. A delete or back icon 603 is provided to clear the current title or to delete the button altogether. After the user selects the buttons and names the buttons, in this case a single button, the user may click on Done 603 to indicate that the user or sender is finished selecting and naming buttons. The action of selecting “Done” cause a new screenshot to appear.

FIG. 7 is a screenshot 701 of the interface of FIG. 1 for setting an action for a custom quick response option. Screen 701 contains the selected button named Share Song. The unselected buttons are still visible and still may be selected if the user decides to add one or more new quick response buttons. In one embodiment the unselected buttons are grayed out in the interface but are still visible to the user. Screen 701 does not have the virtual keyboard input interface displayed because the user indicated that she was finished with selecting and naming the quick response button. A next task will be to set the action for the button that was selected and named.

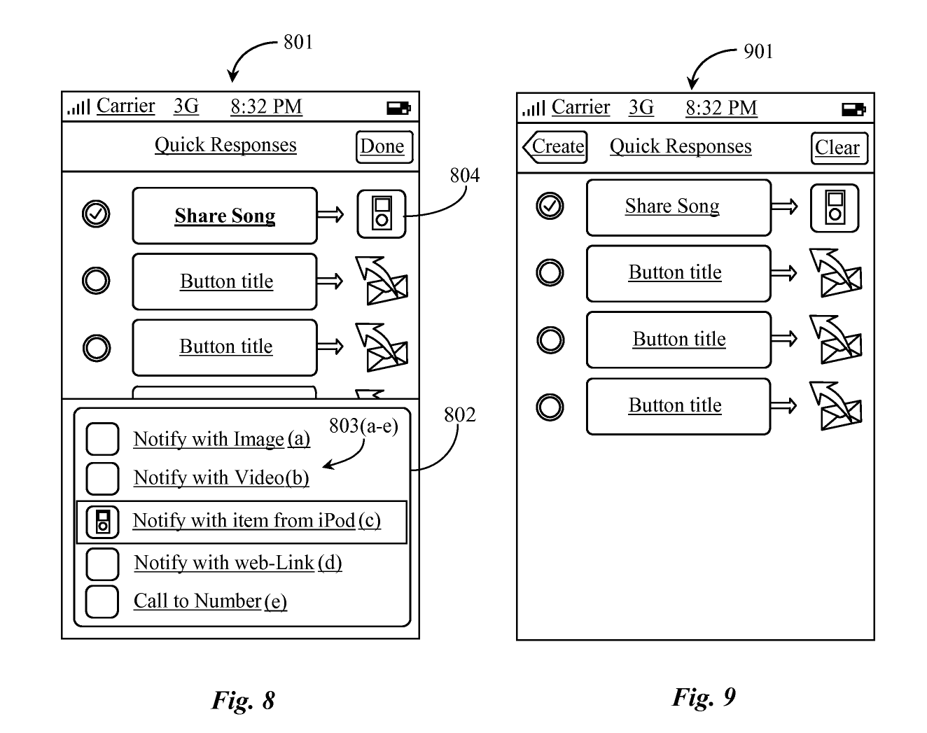

FIG. 8 is a screenshot 801 of the interface of FIG. 1 for setting a notification channel for receiving notification of interaction with the inserted quick response interactive. In one embodiment of the invention a user clicks on the set action button associated with the selected quick response button “Share Song”. This action causes a notification menu 801 to appear that lists some available (supported) notification methods 802 (a-e). The notification serves to notify the sender with a message exactly what occurred in the recipient's session. For example, a notification tells the sender which quick response button the recipient clicked on and in some use cases includes an attached file such as a video, a song, an image, or some other attachment.

In this example, the sender sets the action to action 802 (c) which is “Notify with item from iPod”. In this case, action 803 includes code that includes an .exe file that automatically executes to open up the recipient's iPod library when the recipient clicks on quick response button “Share Song”.

FIG. 9 is a screenshot 901 of the interface of FIG. 1 for setting an action concerning notification relative to recipient interaction with a quick response menu. After the sender has configured all of the buttons and set all of the actions relative to the quick response buttons, the notification options window 801 disappears and configuration is complete. In this case screen 901 is identical to screen 701 accept for the fact that the action for the button “Share Song” is set. In one embodiment when the sender has the button set, the configured button may become a part of an online collection of such buttons available to all users. In another embodiment the button just becomes a new part of that user's repertoire of interactive quick response buttons that may be inserted into any message authored by that user.

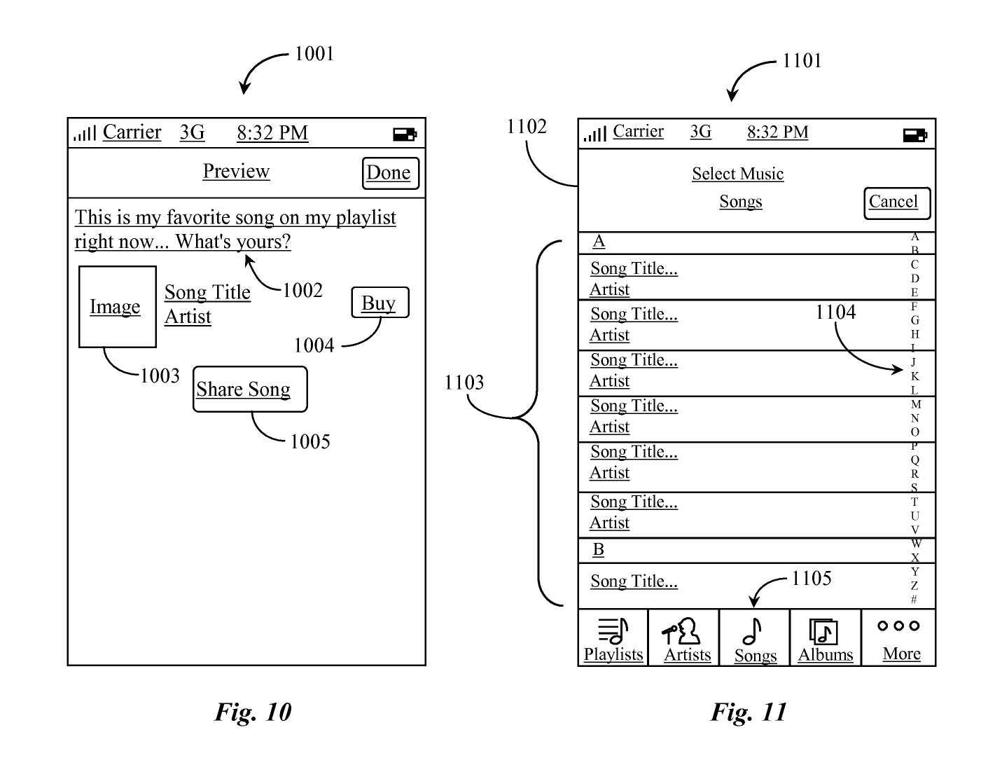

FIG. 10 is a screenshot 1001 of the interface of FIG. 1 for previewing a message sent to a recipient based on the configurations in FIGS. 8 and 9. Screen 1001 includes a message body 1002 that asks the recipient what his or her favorite song is. The message includes a song preview 1003 of the sender's favorite song, which includes an image of the video cover that can also represent a portion of the song that can be played on the recipient's communications device from within the screen. The song preview 1003 includes minimally the song title and the artist of the song. More information about the song, video, artist, album, etc. may be provided as well without departing from the spirit and scope of the present invention.

A “buy” button 1004 is provided with the message in case the recipient wishes to purchase the song. A quick response button 1005 (Share Song) is provided with a set action. The sender wishes the recipient to share his or her favorite song by clicking on the share song quick response button. This quick response button, when activated by clicking on it executes to open the recipient's iPod or other primary or default music playlist.

FIG. 11 is a screenshot 1101 of the interface of FIG. 1 depicting a music playlist opened as a result of interaction with the message of FIG. 10. Screen 1101 includes a title bar 1102 that is relevant to the set action for the quick response button. The action that the sender wishes the recipient to take is share a favorite song. The recipient may select a song from a playlist 1103 that is opened within the messaging interface. The message recipient may select any song in the default playlist and can browse through multiple songs using the alphabet index 1104 provided for navigating through the playlist.

In one embodiment of the present invention if there is more than one playlist the recipient might consider, then the additional lists may be listed under the opened primary or default list. If no list is identified as a default list then the system may determine default by using simple logic like presenting the largest list as a default list and ordering additional lists by size. In another example the logic might utilize the oldest list as a default list and present additional lists in order of age. There are many possibilities. In this example, some of the available settings 1105 relative to searching for songs, artists, albums, playlists, and more are imported into the messaging interface and can be used from within the interface to expedite the search for the recipient's most favorite song to return in the reply message back to the sender.

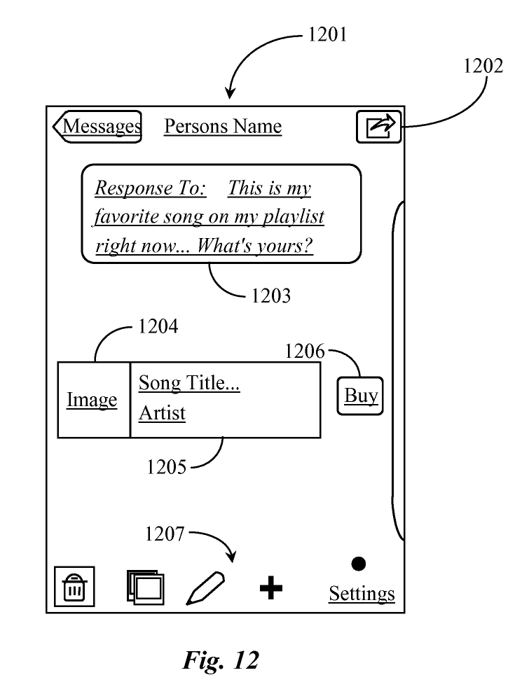

FIG. 12 is a screenshot 1201 of the interface of FIG. 1 depicting a response message to the message of FIG. 10. Screen 1201 displays for the sender and lists the recipients name. A convenient tap-back button is provided for notifying the sender which button was pressed. The message being previewed at the sender's communications device includes the original message sent to the recipient in a messaging window 1203 adapted for the purpose. The recipient's response message includes a song preview in the form of a playable video 1204 represented as a thumbnail image. Identification block 1205 includes the correct title of the song and the correct artist responsible for the song. A buy button 1206 is provided in case the recipient of the reply (sender) wishes to immediately buy the song. The buy button is a URL link to the service provider having the song available for purchase through normal online channels. Available settings 1207 from the sender's music playlist application are imported into the interface for the sender's convenience. In one example, the settings are generic to the messaging interface but can be used to manipulate other applications that can be opened through the messaging interface. It is noted herein that a message recipient may also include one or more quick response buttons in the reply message back to the original sender.

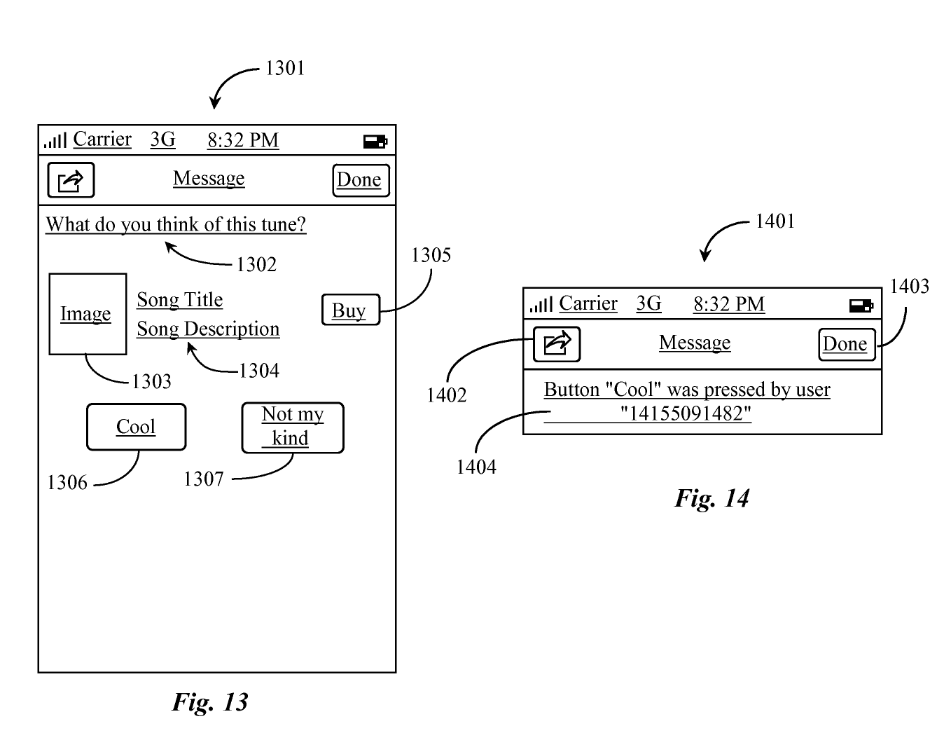

FIG. 13 is a screenshot 1301 of the interface of FIG. 1 depicting another message sent to a recipient. Screen 1301 includes a message body 1302 asking the recipient what the recipient thinks about an included song embedded into the message slide. The song playable thumbnail image 1303 is included along with song title and song description 1304. A buy button 1305 is provided to enable the recipient to purchase the song. The recipient may click on the buy button and navigate to the music store to finish the transaction without ever leaving the messaging interface. The original message may be deferred until the transaction is complete at which time the recipient may resume interaction with the original message.

In this example, the sender asks the recipient if the recipient thinks the song was cool or not my kind. A quick response button 1306 labeled “cool” and a quick response button 1307 labeled “not my kind” are included in the message. In this case the recipient clicks on the quick response button “Cool”, which causes an automated notification reply back to the sender.

FIG. 14 is a screenshot 1401 of the interface of FIG. 1 depicting a response message to the message of FIG. 13. Screen 1401 is a notification message sent back to the sender that notifies the sender that the recipient pressed the quick response button cool. An identification code and or a name may be displayed to the sender so that the sender knows which recipient and message the notification is relevant to.

Screen 1401 includes a “tap-back” button 1402. The standard Tap Back button notifies the sender which button was pressed. In this case, the recipient indicates that the song is cool and the sender is notified <What do you think of this tune?>|<reciepientname> chose “Cool””. A “done” button 1403 is provided should the sender wish to indicate that he or she is done corresponding with the recipient. Screen 1401 includes a message body, which is a system message that the user has selected the button “Cool”.

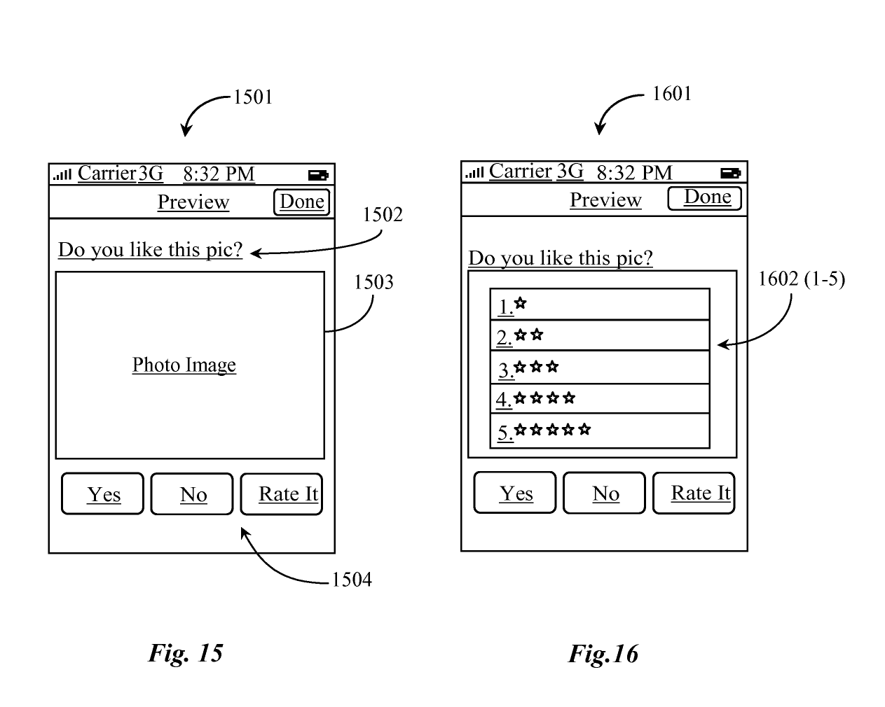

FIG. 15 is a screenshot 1501 of the interface of FIG. 1 depicting a message for rating content. In this example the content is a photo or image 1503. Screen 1501 includes a message body 1502 that asks the recipient if they like the content, in this case a picture. Quick response buttons 1504 are provided in the message for the recipient to select. The quick response buttons are Yes, No, and Rate it. In this example, the recipient selects Rate it, which causes a new screen to appear in the interface.

FIG. 16 is a screenshot 1601 of the interface of FIG. 1 depicting a rating menu invoked from selecting rate it in the screenshot of FIG. 15. Screen 1601 includes a rating menu 1602 (1-5). In this case, the rating options are numbers of stars whereby one star is the lowest rating and five starts is the highest rating possible. If the recipient selects one of rating options 1602 (1-5), then an automated reply to the sender will be initiated with the selection embedded therein for the sender to view as a response message. The only manual work the recipient does is to select the rating option from the menu to reply.

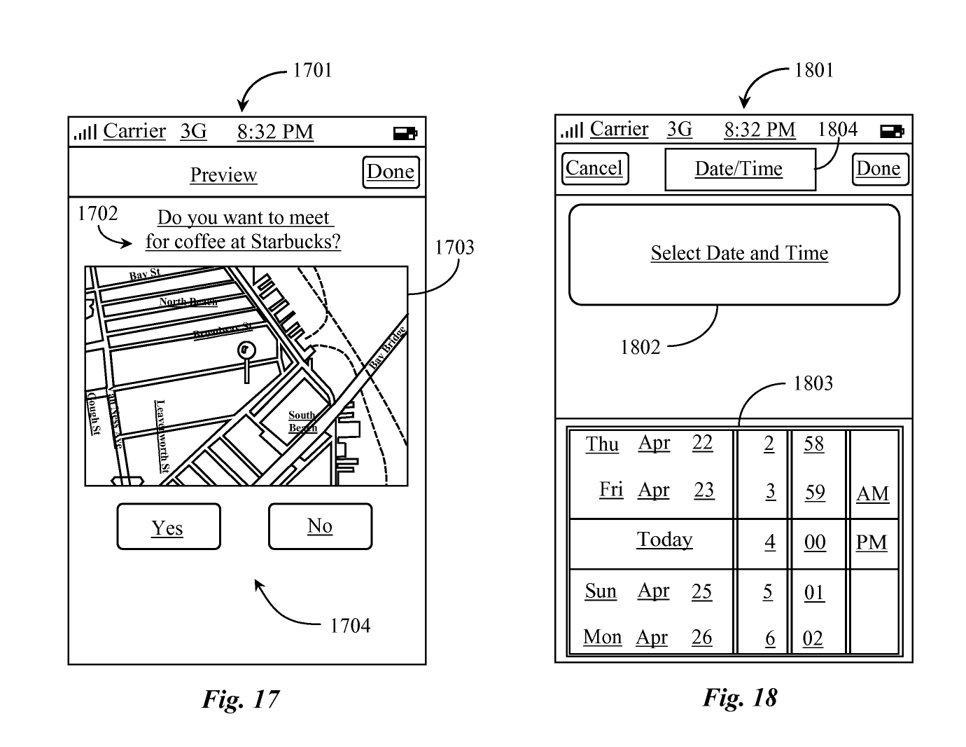

FIG. 17 is a screenshot 1701 of the interface of FIG. 1 depicting a message asking for a meeting. Screen 1701 includes a message body 1702 that asks the recipient if they would like to meet for coffee at a local Starbucks. The sender has included a map 1703 identifying which Starbucks is the one subject to the meeting.

A plurality of quick response buttons 1704 is presented in the message. In this example the recipient selects the button Yes. This selection causes another screen to appear.

FIG. 18 is a screenshot 1801 of the interface of FIG. 1 depicting a date wheel invoked from selecting yes in the screenshot of FIG. 17. Screen 1801 appears as a result of the recipient checking his or her schedule and finding that they can meet the sender and then clicking on the quick response button Yes of FIG. 17. Screen 1801 prompts the recipient to select a date and time, and includes a time and date wheel to make a proposed date and time for the meeting. The time and date selected by the recipient from date wheel 1803 will be sent back to the sender in an automated notification message that includes the location information for the meeting.

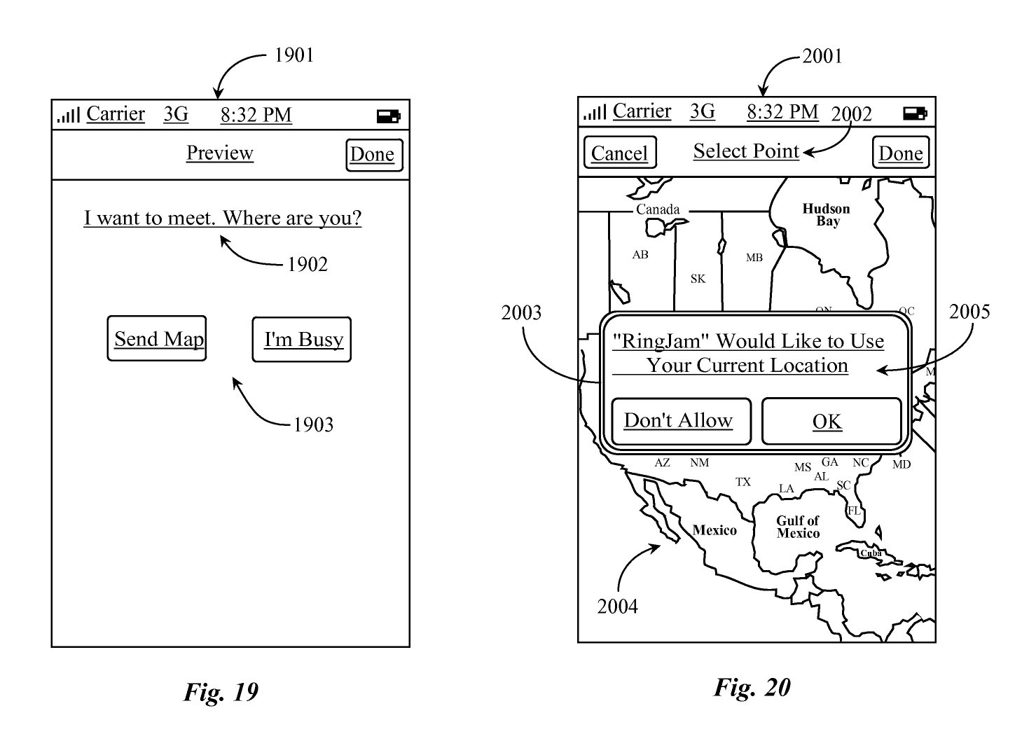

FIG. 19 is a screenshot 1901 of the interface of FIG. 1 depicting a message asking for location for a meeting. Screen 1901 includes a message body 1902 informing the recipient that the sender wants to meet and asking the recipient for location information. Screen 1901 includes the quick response buttons 1903 “Send Map”, and “I'm Busy”. In this example, the recipient selects the quick response option for sending the map of the recipient's location. This action causes a new screen to appear in the interface.

FIG. 20 is a screenshot 2001 of the interface of FIG. 1 depicting a map and asking for permission to use the current GPS location coordinates. Screen 2001 includes a prompt 2002 to the recipient asking to select a point on a map 2004 that appears in the interface. In this case, a system message pops up in the interface to ask the recipient for permission to report exact location using GPS coordinates. However, the user reserves the right not to reveal an exact location by clicking the “Don't Allow” button. If the recipient clicks OK then the exact location would be sent to the message sender immediately. In one embodiment the recipient could type in an address instead of reporting coordinates and generating a map of the location.

Alternatively the sender could just send a message that asks the recent “Where are you? The recipient has the option of submitting to location reporting or may enter an address. Other ways of revealing location might be undertaken in this exchange without departing from the spirit and scope of the present invention. In one example, the sender may ask “Where are you?” and the recipient might send a name of a venue, business, park, or other well-known location to the sender complete with a map, telephone number and address if such granularity is appropriate.

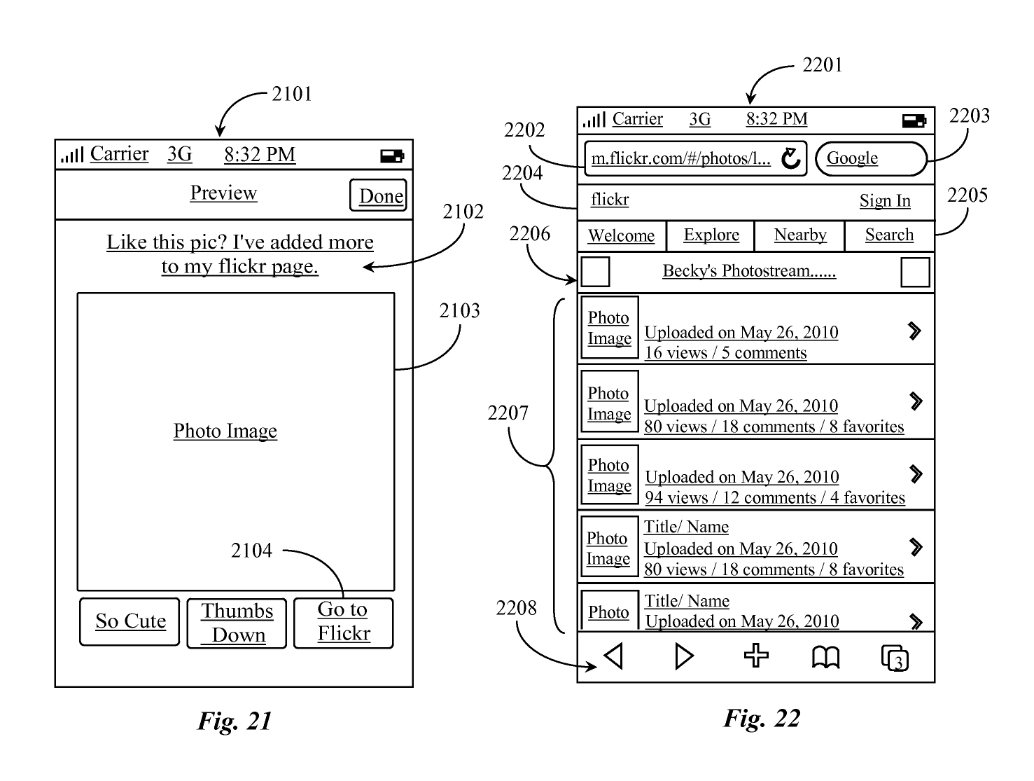

FIG. 21 is a screenshot 2101 of the interface of FIG. 1 depicting a message inviting a recipient to a content hosting Web page. Screen 2101 includes a message body 2102 that asks the recipient if they like content inserted into or otherwise attached to the message, and then invites the recipient to a content page hosted on the internet network. In this example, the content is a photo 2103. The sender has included the quick response buttons 2104 “So Cute”, “Thumbs Down”, and “Go to Flickr”. In this case Flickr, a well-known photo hosting site is the host of the content. In this example, the recipient clicks on “Go to Flickr” which causes automated navigation and login to Flickr as a guest of the sender. Navigation is provided by pre-programming the quick response button “Go to Flickr” with a URL that displays the sender's Flickr page in the interface as will be seen below.

FIG. 22 is a screenshot 2201 of the content page navigated to as a result of interaction with a quick response button in the message of FIG. 21. Screen 2201 includes an online Flickr page formatted for view on the recipient's communication device display screen. A navigation bar 2202 containing the URL and URI is present in the screen as well as a standard Google search interface 2203 should the recipient wish to jump into a search activity from the interface. Bar 2204 includes the title Flickr and a sign-in option for the recipient to sign-in to his or her own Flickr account. Other standard navigation and search options 2205 are also included into the interface screen such as Welcome, Explore, Near by, and Search.

The sender's photo stream is open for the recipient to browse. The current spot in the stream is earmarked by photos 2207 that are visible in the window. Photo navigation buttons and other tools 2208 from Flickr are included at the bottom of the screen so that the recipient might browse more efficiently. Scroll bars, zoom controls, file menus, and the like may also be provided to improve the functionality of the recipient's experience from the point of a mobile communications device. The functionality exemplified by code included with a quick response button may only be temporary such that URL navigation and the like must be re-optioned in a quick response button in the message to enable repetition of such actions. In other cases, links may be save able on the recipient's device so that repeat visiting can be performed without further invitation through the messaging system of the present invention.

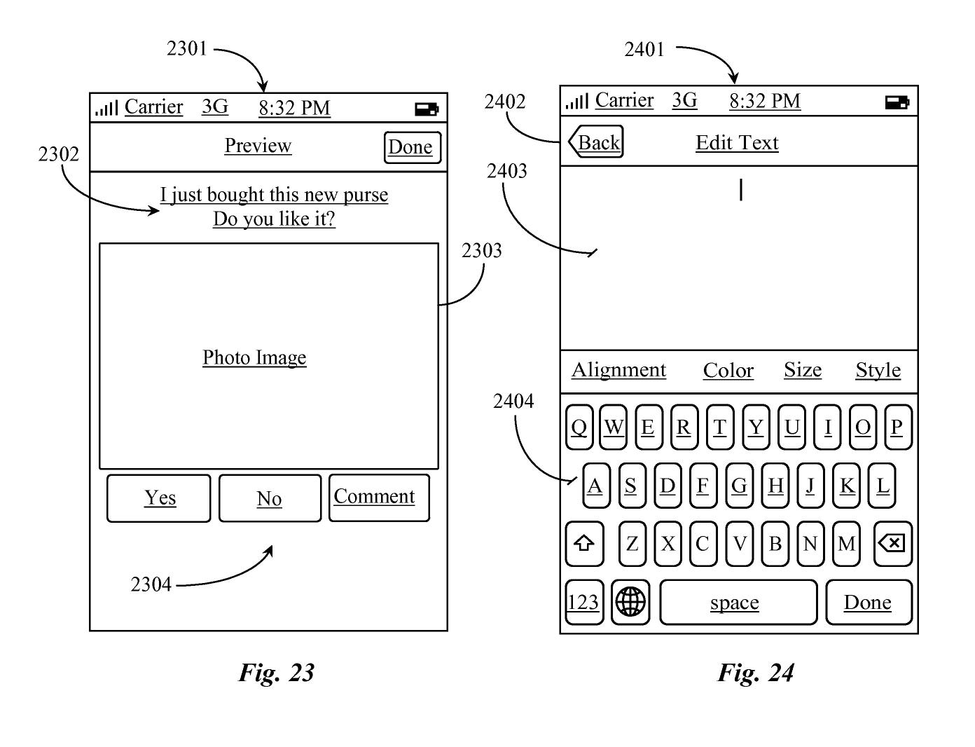

FIG. 23 is a screenshot 2301 of the interface of FIG. 1 depicting a message asking the recipient to comment on a photo in the message. As presented further above, screen 2301 contains a message body 2302 asking the recipient if they like some inserted content. In this case, the content inserted into the message is a photo 2303, presumably a purse. In one embodiment a buy button may accompany the photo. An advertising campaign might solicit users whom have purchased certain items to sell the item to one or more of their friends so that they might receive some price roll back or discount on the same or another item. Quick response buttons 2304 include a Yes button, a No button, and a Comment button. In this example, the recipient clicks on the comment button and a new screen appears in the interface.

FIG. 24 is a screenshot 2401 of the interface of FIG. 1 depicting a messaging window and keyboard for forming the comment requested in the message of FIG. 23. Screen 2401 includes a prompt bar and a back button 2402. Screen 2401 includes a text box for typing in a comment using a virtual keyboard 2404. A done button is provided for send after the text editing is finished. The recipient simply types in the comment and hits done to have the reply sent back to the sender.

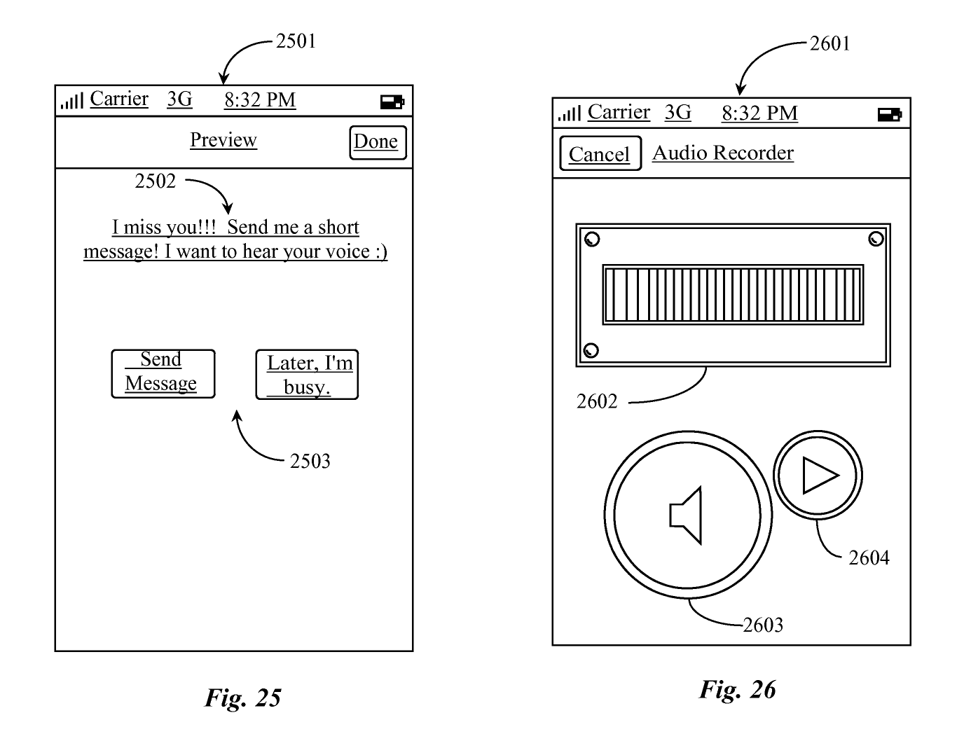

FIG. 25 is a screenshot 2501 of the interface of FIG. 1 depicting a message requesting the recipient to send a voice message in reply. Screen 2501 contains a message body 2502 that requests the recipient to send a voice message. Quick response buttons 2503 include “Send Message” and “Later, I'm busy. In this example, the recipient clicks on send message causing a new screen to appear that includes a voice recording function. In one embodiment the sender may record a voice message and store it under a “hear” icon in the original message instead of typing a text message.

FIG. 26 is a screenshot 2601 of the interface of FIG. 1 depicting an audio recording utility displayed in the interface for recording audio for the reply message. Screen 2601 includes an audio recorder 2602 for use in recording the recipient's voice for a message reply. The utility includes a record button 2604 and a playback control 2603. The recipient simply records his or her own voice and the reply is sent back to the sender as a voice message. In one embodiment the voice recording utility is invoked from the communications device of the recipient and used to record the voice of the recipient for automatic reply. In another embodiment the recorder utility is hosted at the supporting server online such as AS 116 of FIG. 1. It is noted herein that the voice recording utility may be a video recording utility instead and the reply message might be a video message.

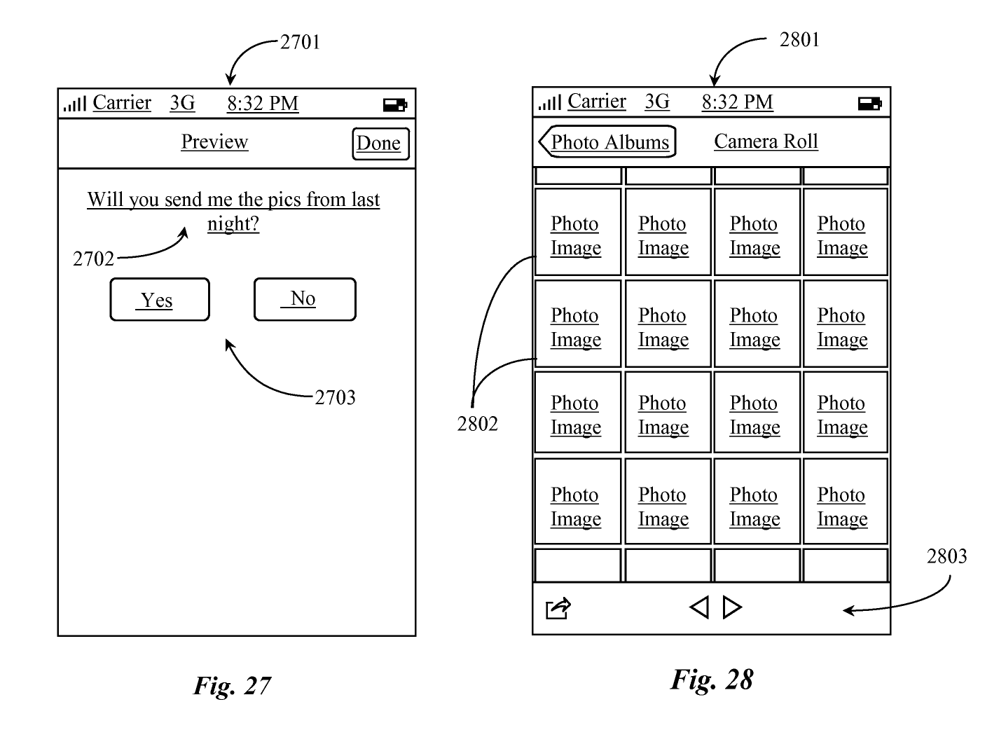

FIG. 27 is a screenshot 2701 of the interface of FIG. 1 depicting a message requesting that the recipient send photos. Screen 2701 contains a message body 2702 requesting that the recipient send pictures to the sender that were recently taken. The sender has included quick response buttons 2703 including a “Yes” and “No”. In this example the recipient clicks on the Yes button causing a new screen to appear that contains a photo collection or digital camera roll.

FIG. 28 is a screenshot 2801 of the interface of FIG. 1 depicting a photo collection in the interface for enabling the recipient to select one or more photos for insert into a reply message. Screen 2801 includes a collection of photos 2802 resident on the recipient's communication device memory. Photos 2802 may represent all of the recipient's photos, or those from a specific date and time such as photos recently taken. Screen 2803 includes some standard navigation tools for browsing the photo collection to find the appropriate photos. In one embodiment, the quick response button not only includes code for locating and opening the photo collection on the device but also includes code (parser) for reading the metadata about each photo. In this way the automated process may determine which of the photos is a good candidate for matching the original message constraint of FIG. 27 (“pics from last night”). The content could also be video clips or documents instead of photos without departing from the spirit and scope of the present invention.

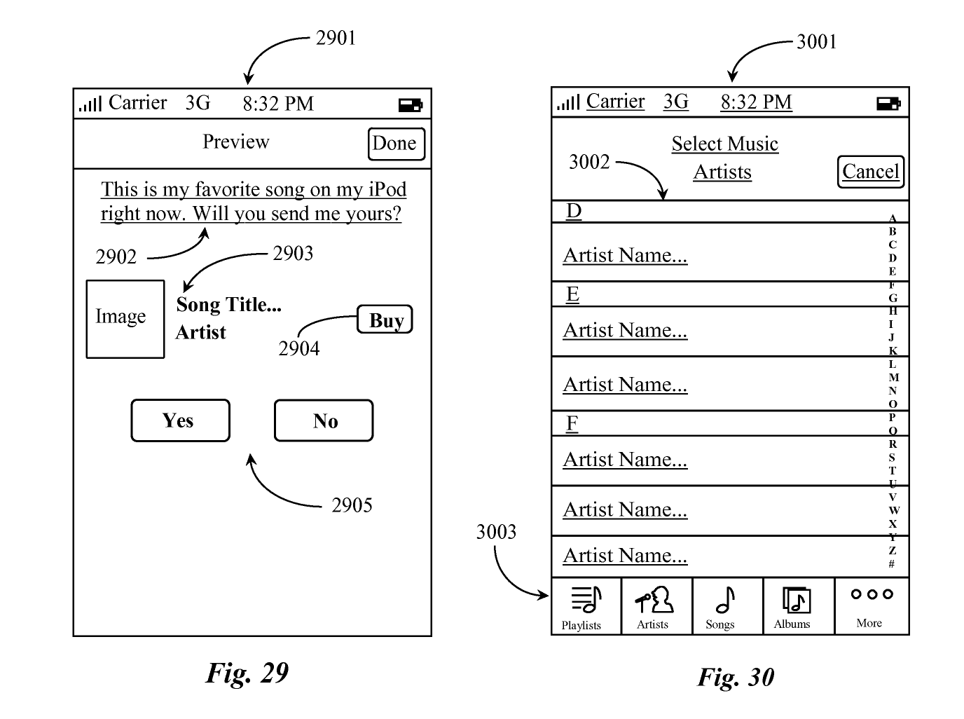

FIG. 29 is a screenshot 2901 of the interface of FIG. 1 depicting a message asking the recipient to send a song preview. Screen 2901 includes a message body 2902 that informs the recipient of the sender's favorite song on the sender's iPod and asks to receive the recipient's favorite song on the recipient's iPod. Text message body 2902 may be an audio message or video message without departing from the spirit and scope of the present invention. Screen 2901 includes the song metadata 2903 from the sender including the song title, the artist identification, and an image representing the song, the artist, or the album. The image might actually be an audio clip or preview of the song and may include a play and pause button so the recipient can play the song from the sender before responding.

The sender has included a buy button should the recipient wish to immediately purchase the song. In one embodiment the recipient may purchase the song without leaving the current messaging application interface. In this case the quick response buttons 2905 are simple “Yes” and “No” buttons. The recipient clicks on Yes in this example. Clicking on Yes causes another screen to appear in the interface that includes one or more photo collections on the recipient's device.

FIG. 30 is a screenshot 3001 of the interface of FIG. 1 depicting a music collection opened in the interface for enabling the recipient to select a song for insert into a reply message. Screen 3001 opens automatically as a result of the recipient click on the Yes button of previous FIG. 29. The yes button includes a code that opens up the playlist or other collection of music the user might have in memory on the communications device. In one embodiment the code contains a URL that opens a remote set of songs the user can access from his or her communications device.

Screen 3001 includes the music collection of the recipient and the recipient may select one or more of the songs for preview and send. Screen 3001 includes some standard tools 3003 that enable the recipient to navigate items by playlist, by artists, by individual songs, by music albums and so on. In one embodiment the sender may place the song to execute and run in the background behind the text message request so the recipient only has to open the message to hear the song. There are many possibilities.

It will be apparent to one with skill in the art that the examples cited above are use cases that specify what content and actions are involved in different situations under the practice of the present invention. The general process of utilizing quick response buttons in messaging involves the processes of selection, configuration, and insertion relative to each available quick response. Actions can be assigned to quick response buttons and actions may be different for two like quick response buttons. Each action set or configured for a quick response button depends in part on what the sender wants the recipient to do after receiving a message, and in part on the content of the message itself.

In some embodiments a sender will create a new action for a standard response button. In other embodiments a sender will create a new response button and assign a stock action to the button. In still other embodiments a sender will create a quick response button and the associated action.

Creating an action may be dependant in part on the available coding. In the case of an executable, if the executable is standard for the application on any communications device and platform, then it may be used universally. However, some executables and applications might be proprietary such that permission must be granted by the application vendor or provider to obtain or create an executable for the proprietary third party application such as in order to avoid privacy violations and the like. For example, in all of the messaging use cases cited, the recipient must take some action or otherwise give permission for the executable to open, for example, a picture collection on the recipient's device where one or more pictures inside are to be shared with another. The recipient has the last opportunity to opt out of any transaction initiated through the messaging application.

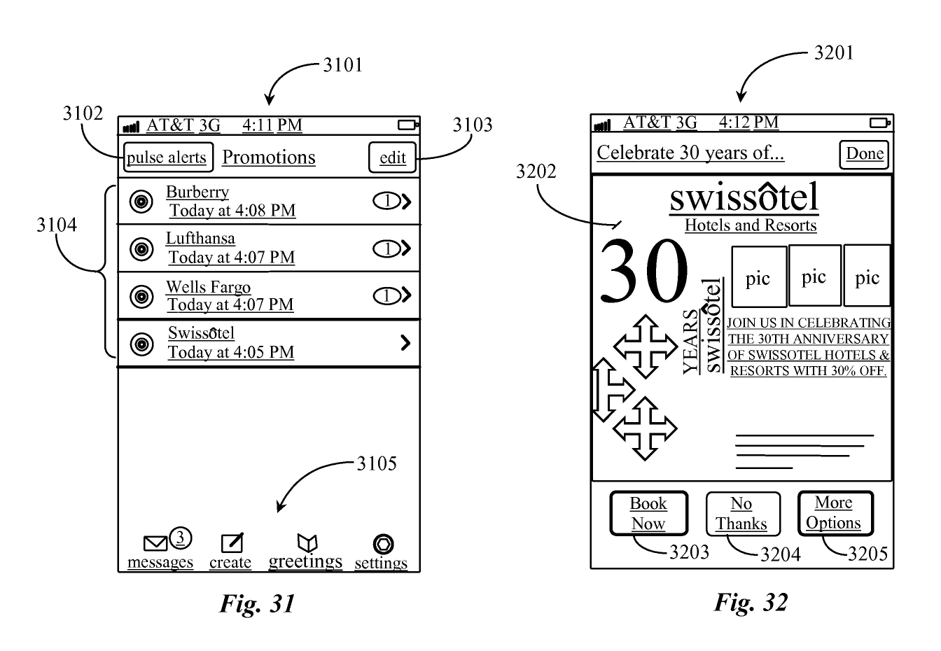

FIG. 31 is a screen shot 3101 depicting a list of promotional messages received as a result of opting in to receive such advertisements. As described further above with respect to FIG. 1, the present invention may be practiced by advertisers who wish to target mobile users whereby dynamic quick response buttons may be used to interact with a received advertisement to open contact channels or other communication with the advertising entity.

Screen 3101 includes an interactive button 3102 labeled Pulse Alerts. Button 3102 may be invoked to see a list of promotional messages such as list 3104 displayed in screen 3101 in this example. An edit button is provided for editing the settings relative to how messages are listed and displayed and perhaps what types of messages are allowed to be received by the user.

Promotional messages 3104 include the advertiser name, the time of receipt of the promotional message, and an indication of the number of messages under each listing. In this example the advertisers are Burberry, Lufthansa, Wells Fargo, and Swissotel. Each advertiser is associated with a single message in list 3104, however, it is possible that an advertiser has more than one unread message in the list. Upon expanding the list, all messages can be seen. Screen 3101 includes options 3105 at the bottom of the screen. For example, an indication of the number of unread messages (3) is provided as well as a link to create a pulse message or message reply. A link for sending greetings and a link to system settings is also provided. There may be more or fewer options of varying types in screen 3101 without departing from the spirit and scope of the present invention.

In this example, the recipient of messages 3104 has selected the last advertiser in the list to view messages from that advertiser. In one embodiment the recipient has given prior authorization to the advertiser to send promotional messages to the user's communications or computing appliance. Invoking the advertiser through the touch screen causes a new screen to appear (not illustrated) that shows the unopened message with a message summary such as “Celebrate 30 Years of Swissotel!”. In this case there is only one promotional message under the advertiser Swissotel. Therefore an intermediate screen showing an unopened message with a message summary may be bypassed and a next screen displaying the promotional message opened for the recipient may instead appear when the advertiser name is invoked through the touch screen when there is but a single message to view. In a case where there are multiple messages, the intermediate screen showing a list of promotional messages received under that advertising entity may be presented for the recipient to choose which message to open.

FIG. 32 is a screen shot 3201 depicting the promotional message under the advertiser name (Swissotel) selected in the example of FIG. 31. Screen 3201 presents a promotional message 3202 that comprises a graphics and text advertisement promoting 30 years of business for Swissotel hotels and resorts. The promotion offers the recipient 30% off of the prices to stay at any of the available or participating venues.

The advertiser has provided and set actions for quick response buttons 3203, 3204, and 3205. Option 3203 labeled “book now” opens an interactive menu of booking options for the recipient if invoked. Option 3204 labeled “no thanks” sends notification back to the advertiser that the recipient is not interested. Option 3205 labeled “more options” opens an interactive menu containing further options for interaction for the recipient to consider if invoked.

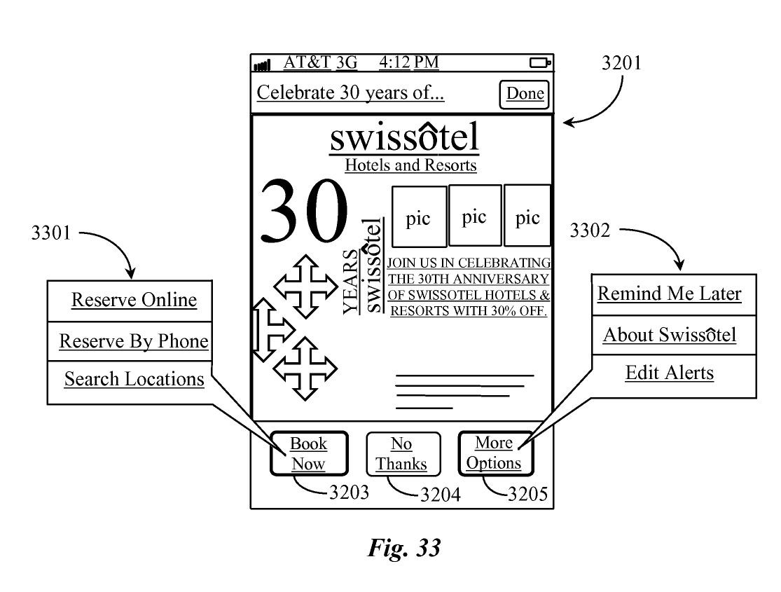

FIG. 33 is the screen shot of FIG. 32 illustrating the more granular quick response options available by invoking the original interactive buttons. Options 3301 available under “book now” 3203 are, reading from the top down, reserve online, reserve by telephone, and search locations. Invoking the first option in list 3301 immediately causes navigation to a Web site or Web form for making a reservation. Invoking the second option in list 3301 results in presentation of a call button or displays a telephone number for the recipient to call using a telephone or computing appliance adapted for telephony. Invoking the third option immediately opens a search tool or interface for finding hotel or resort locations for booking through a found location.

Options 3302 available under “more options” 3205 are, reading from the top down, remind me later, about Swissotel, and edit alerts. Invoking the first option in list 3302 immediately sends a response to the advertiser to send a reminder message at a later date. There may be additional options for specifying the date and time to receive the reminder. Invoking the second option in list 3302 opens a link to an “about us” page or document that explains to the recipient what the entity is all about. Invoking the third option in list 3302 opens a new screen for enabling the recipient to edit alerts including naming advertisers that may send promotional ads and editing any settings or preferences about how the ads are received, listed, and displayed, and perhaps what types of promotional content from the advertiser that the recipient wishes to receive or is okay to send.

It will be apparent to one with skill in the art that the messaging system of the invention may be provided using some or all of the mentioned features and components without departing from the spirit and scope of the present invention. It will also be apparent to the skilled artisan that the embodiments described above are specific examples of a single broader invention which may have greater scope than any of the singular descriptions taught. There may be many alterations made in the descriptions without departing from the spirit and scope of the present invention.

What is claimed is:

1. A system for communication, comprising:
a network-connected server enabled for communication with individual ones of a plurality of network-connected computerized appliances; and
software executing on the server from a machine-readable physical medium;
wherein the software executing at the server provides an interactive interface to a subscriber, on a display of the subscriber's computerized appliance, for creating a message to be sent to an intended recipient's computerized appliance, the interactive interface provided to the subscriber providing functionality for the subscriber to dynamically select a quick-response format, to select a recipient or enter a destination for a recipient, to enter a message body, and to trigger sending of the message, and the message, when sent, includes executable code that provides an interactive interface on a display of the recipient's computerized appliance of at least the message body and one or more quick-response interactive soft keys dictated by the format selected by the subscriber in preparing the message, such that the recipient may select one of the soft keys to send a response back to the subscriber.

2. The system of claim 1 wherein the subscriber's computerized appliance is one of a cellular telephone, a desktop computer, a laptop computer, a personal digital assistant, or a digital pad device with a touch screen display.

3. The system of claim 1 wherein the recipient is also a subscriber, and the system stores information about potential recipients, including types of computerized appliances associated with the intended recipients and addresses for sending messages to those devices, such that a subscribe preparing a message may select recipients from stored data, and may also select appliances associated with recipients.

4. The system of claim 1 wherein the quick-response formats selectable by a subscriber in preparing a message to be sent define one or more pre-stored soft keys for the recipient's display.

5. The system of claim 1 wherein the quick-response formats selectable by a subscriber in preparing a message to be sent include functionality enabling the subscriber to create one or more new soft keys to be provided in a recipient's display.

6. The system of claim 1 wherein the quick-response format selected provides executable code sent with the message that causes activity at a recipient's computerized appliance in addition to or instead of one or more interactive soft keys.

7. The system of claim 6 wherein the activity triggered at the recipient's appliance is connection to a digital storage coupled to the recipient's appliance.

8. The system of claim 7 wherein the activity further comprises retrieval of data from the digital storage.

9. The system of claim 1 wherein the software executing on the server provides archival and historical storage of messages sent and received, and access for subscribers to the stored data.

10. The system of claim 1 wherein the software executing on the server provides a personalized page to a subscriber, wherein the subscriber may manage personalized quick-response formats.

11. A method for communication, comprising:
(a) connecting to a network-connected server by a subscriber operating a computerized appliance;
(b) accessing by the subscriber an interactive interface provided by software executing on the server;
(c) selecting by the subscriber in the interactive interface provided by the server, a quick-response format, a recipient or a destination for a recipient;
(d) entering by the subscriber a message body and triggering sending of the message;
(e) transmitting by the sever the message to the recipient's computerized appliance, the message including interactive code that provides an interactive interface on a display of the recipient's computerized appliance of at least the message body and one or more quick-response interactive soft keys dictated by the format selected by the subscriber in preparing the message, such that the recipient may select one of the soft keys to send a response back to the subscriber.

12. The method of claim 11 wherein, in step (a), the subscriber's computerized appliance is one of a cellular telephone, a desktop computer, a laptop computer, a personal digital assistant, or a digital pad device with a touch screen display.

13. The method of claim 11 wherein, in step (c), the recipient is also a subscriber, and the system stores information about potential recipients, including types of computerized appliances associated with the intended recipients and addresses for sending messages to those devices, such that a subscriber preparing a message may select recipients from stored data, and may also select appliances associated with recipients.

14. The method of claim 11 wherein, in step (c), the quick-response formats selectable by a subscriber in preparing a message to be sent define one or more pre-stored soft keys for the recipient's display.

15. The method of claim 11 wherein, in step (c), the quick-response formats selectable by a subscriber in preparing a message to be sent include functionality enabling the subscriber to create one or more new soft keys to be provided in a recipient's display.

16. The method of claim 11 wherein, in step (c), the quick-response format selected provides executable code sent with the message that causes activity at a recipient's computerized appliance in addition to or instead of one or more interactive soft keys.

17. The method of claim 16 wherein the activity triggered at the recipient's appliance is connection to a digital storage coupled to the recipient's appliance.

18. The method of claim 17 wherein the activity further comprises retrieval of data from the digital storage.

19. The method of claim 11 wherein the software executing on the server additionally provides archival and historical storage of messages sent and received, and access for subscribers to the stored data.

20. The method of claim 11 wherein the software executing on the server additionally provides a personalized page to a subscriber, wherein the subscriber may manage personalized quick-response formats.
